(19) United States
(12) Patent Application Publication
(10) Pub. No.: US 2011/0251704 A1
(43) Pub. Date: Oct. 13, 2011

(54) ADAPTIVE ENVIRONMENTAL NOISE COMPENSATION FOR AUDIO PLAYBACK

(76) Inventors: Martin Walsh, Scotts Valley, CA (US); Edward Stein, Capitola, CA (US); Jean-Marc Jot, Aptos, CA (US); James D. Johnston, Redmond, WA (US)

(21) Appl. No.: 13/084,298

(22) Filed: Apr. 11, 2011

Related U.S. Application Data
(60) Provisional application No. 61/322,674, filed on Apr. 9, 2010.

(51) Int. Cl. G06F 17/00

(52) U.S. Cl. 700/94

(57) ABSTRACT

The present invention counterbalances background noise by applying dynamic equalization. A psychoacoustic model representing the perception of masking effects of background noise relative to a desired foreground soundtrack is used to accurately counterbalance background noise. A microphone samples what the listener is hearing and separates the desired soundtrack from the interfering noise. The signal and noise components are analyzed from a psychoacoustic perspective and the soundtrack is equalized such that the frequencies that were originally masked are unmasked. Subsequently, the listener may hear the soundtrack over the noise. Using this process the EQ can continuously adapt to the background noise level without any interaction from the listener and only when required. When the background noise subsides, the EQ adapts back to its original level and the user does not experience unnecessarily high loudness levels.

### CROSS-REFERENCE TO RELATED APPLICATIONS

The present invention claims priority of U.S. Provisional Patent Application Ser. No. 61/322,674 filed Apr. 9, 2009, to inventors Walsh et al. U.S. Provisional Patent Application Ser. No. 61/322,674 is hereby incorporated herein by reference.

### STATEMENT RE: FEDERALLY SPONSORED RESEARCH/DEVELOPMENT

Not Applicable

### BACKGROUND

1. Technical Field

The present invention relates to audio signal processing, and more particularly, to the measurement and control of the perceived sound loudness and/or the perceived spectral balance of an audio signal.

2. Description of the Related Art

The increasing demand for ubiquitously accessing content through various wireless communication means has resulted in technologies being equipped with superior audio/visual processing equipment. In this regard, televisions, computers, laptops, mobile phones, and the like have enabled individuals to view multimedia content while roaming in a variety of dynamic environments, such as airplanes, cars, restaurants, and other public and private places. These and other such environments are associated with considerable ambient or background noise which makes it difficult to comfortably listen to audio content.

As a result, consumers are required to manually adjust the volume levels in response to loud background noise. Such a process is not only tedious, but also ineffective if replaying content a second time at a suitable volume. Furthermore, manually increasing volume in response to background noise is undesirable since the volume must later be manually decreased to avoid acutely loud reception when the background noise dies down.

Therefore, there is a present need in the art for improved audio signal processing techniques.

### BRIEF SUMMARY

In accordance with the present invention, there are provided multiple embodiments of an environment noise compensation method, system, and apparatus. The environment noise compensation method is based on the physiology and neuropsychology of a listener, including the commonly understood aspects of cochlear modeling and partial loudness masking principals. In each embodiment of the environment noise compensation method, an audio output of the system is dynamically equalized to compensate for environmental noises, such as those from an air conditioning unit, vacuum cleaner, and the like, which would have otherwise masked (audibly) the audio to which the user was listening to. In order to accomplish this, the environment noise compensation method uses a model of the acoustic feedback path to estimate the effective audio output and a microphone input to measure the environmental noise. The system then compares these signals using a psychoacoustic ear-model and computes a frequency-dependent gain which maintains the effective output at a sufficient level to prevent masking.

The environment noise compensation method simulates an entire system, providing playback of audio files, master volume control, and audio input. In certain embodiments, the environment noise compensation method further provides automatic calibration procedures which initialize the internal models for acoustic feedback as well as the assumption of the steady-state environment (when no gain is applied).

In one embodiment of the present invention, a method for modifying an audio source signal to compensate for environmental noise is provided. The method includes the steps of receiving the audio source signal; parsing the audio source signal into a plurality of frequency bands; computing a power spectrum from magnitudes of the audio source signal frequency bands; receiving an external audio signal having a signal component and a residual noise component; parsing the external audio signal into a plurality of frequency bands; computing a external power spectrum from magnitudes of the external audio signal frequency bands; predicting an expected power spectrum for the external audio signal; deriving a residual power spectrum based on differences between expected power spectrum and the external power spectrum; and applying a gain to each frequency band of the audio source signal, the gain being determined by a ratio of the expected power spectrum and the residual power spectrum.

The predicting step may include a model of the expected audio signal path between the audio source signal and the associated external audio signal. The model initializes based on a system calibration having a function of a reference audio source power spectrum and the associated external audio power spectrum. The model may further include an ambient power spectrum of the external audio signal measured in the absence of an audio source signal. The model may incorporate a measure of time delay between the audio source signal and the associated external audio signal. The model may continuously be adapted based on a function of the audio source magnitude spectrum and the associated external audio magnitude spectrum.

The audio source spectral power may be smoothed such that the gain is properly modulated. It is preferred that the audio source spectral power is smoothed using leaky integrators. A cochlear excitation spreading function is applied to the spectral energy bands mapped on an array of spreading weights, the array of spreading weights having a plurality of grid elements

In an alternative embodiment a method for modifying an audio source signal to compensate for environmental noise is provided. The method includes the steps of receiving the audio source signal; parsing the audio source signal into a plurality of frequency bands; computing a power spectrum from magnitudes of the audio source signal frequency bands; predicting an expected power spectrum for an external audio signal; looking up a residual power spectrum based on a stored profile; and applying a gain to each frequency band of the audio source signal, the gain being determined by a ratio of the expected power spectrum and the residual power spectrum.

In an alternative embodiment, an apparatus for modifying an audio source signal to compensate for environmental noise is provided. The apparatus comprises a first receiver processor for receiving the audio source signal and parsing the audio source signal into a plurality of frequency bands, wherein a power spectrum is computed from magnitudes of the audio source signal frequency bands; a second receiver processor for receiving an external audio signal having a signal component and a residual noise component, and for parsing the external audio signal into a plurality of frequency bands, wherein an external power spectrum is computed from magnitudes of the external audio signal frequency bands; and a computing processor for predicting an expected power spectrum for the external audio signal, and deriving a residual power spectrum based on differences between expected power spectrum and the external power spectrum, wherein a gain is applied to each frequency band of the audio source signal, the gain being determined by a ratio of the expected power spectrum and the residual power spectrum.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a schematic view of one embodiment of an Environmental Noise Compensation environment including a listening area and microphone;

FIG. 2 illustrates provides a flow chart that sequentially details various steps performed by one embodiment of the Environment Noise Compensation method;

FIG. 3 provides a flow diagram of an alternative embodiment of the Environment Noise Compensation environment having an initialization processing block and adaptive parameter updates;

FIG. 4 provides a schematic view of the ENC processing block according to one embodiment of the present invention;

FIG. 5 provides a high level block processing view of Ambient Power Measurement;

FIG. 6 provides a high level block processing view of Power Transfer Function Measurement;

FIG. 7 provides a high level block processing view of a two-stage calibration process according to an optional embodiment;

FIG. 8 provides a flow chart depicting the steps when a listening environment changes after an initialization procedure has been performed.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

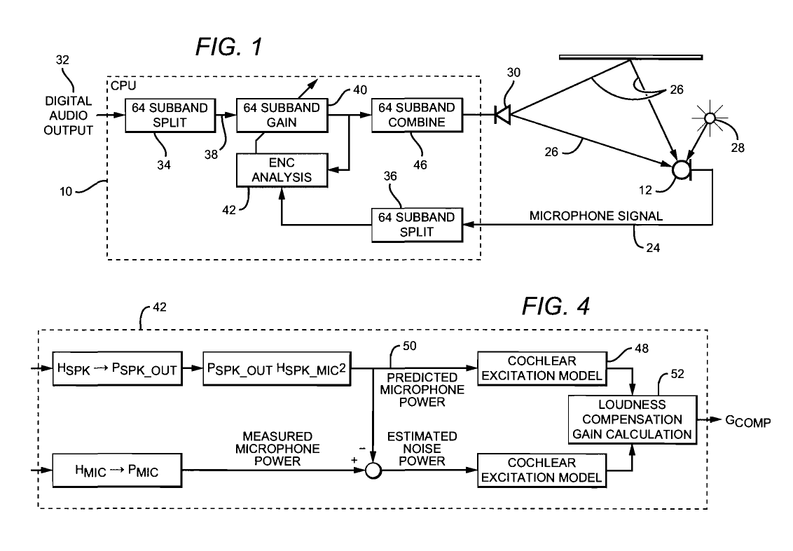

With reference to FIG. 1, a basic Environment Noise Compensation (ENC) environment includes a computer system with a Central Processing Unit (CPU) 10. Devices such as a keyboard, mouse, stylus, remote control, and the like, provide input to the data processing operations, and are connected to the computer system 10 unit via conventional input ports, such as USB connectors or wireless transmitters such as infrared. Various other input and output devices may be connected to the system unit, and alternative wireless interconnection modalities may be substituted.

As shown in FIG. 1, the Central Processing Unit (CPU) 10, which may represent one or more conventional types of such processors, such as an IBM PowerPC, Intel Pentium (x86) processors, or conventional processors implemented in consumer electronics such as televisions or mobile computing devices, and so forth. A Random Access Memory (RAM) temporarily stores results of the data processing operations performed by the CPU, and is interconnected thereto typically via a dedicated memory channel. The system unit may also include permanent storage devices such as a hard drive, which are also in communication with the CPU 10 over an i/o bus. Other types of storage devices such as tape drives, Compact Disc drives, and the like, may also be connected. A sound card is also connected to the CPU 10 via a bus, and transmits signals representative of audio data for playback through speakers. A USB controller translates data and instructions to and from the CPU 10 for external peripherals connected to the input port. Additional devices such as microphones 12, may be connected to the CPU 10.

The CPU 10 may utilize any operating system, including those having a graphical user interface (GUI), such as WINDOWS from Microsoft Corporation of Redmond, Wash., MAC OS from Apple, Inc. of Cupertino, Calif., various versions of UNIX with the X-Windows windowing system, and so forth. Generally, the operating system and the computer programs are tangibly embodied in a computer-readable medium, e.g. one or more of the fixed and/or removable data storage devices including the hard drive. Both the operating system and the computer programs may be loaded from the aforementioned data storage devices into the RAM for execution by the CPU 10. The computer programs may comprise instructions or algorithms which, when read and executed by the CPU 10, cause the same to perform the steps to execute the steps or features of the present invention. Alternatively, the requisite steps required to perform present invention may be implemented as hardware or firmware into a consumer electronic device.

The foregoing CPU 10 represents only one exemplary apparatus suitable for implementing aspects of the present invention. As such, the CPU 10 may have many different configurations and architectures. Any such configuration or architecture may be readily substituted without departing from the scope of the present invention.

The basic implementation structure of the ENC method as illustrated in FIG. 1 presents an environment that derives and applies a dynamically changing equalization function to the digital audio output stream such that the perceived loudness of the ‘desired’ soundtrack signal is preserved (or even increased) when an extraneous noise source is introduced into the listening area. The present invention counterbalances background noise by applying dynamic equalization. A psychoacoustic model representing the perception of masking effects of background noise relative to a desired foreground soundtrack is used to accurately counterbalance background noise. A microphone 12 samples what the listener is hearing and separates the desired soundtrack from the interfering noise. The signal and noise components are analyzed from a psychoacoustic perspective and the soundtrack is equalized such that the frequencies that were originally masked are unmasked. Subsequently, the listener may hear the soundtrack over the noise. Using this process the EQ can continuously adapt to the background noise level without any interaction from the listener and only when required. When the background noise subsides, the EQ adapts back to its original level and the user does not experience unnecessarily high loudness levels.

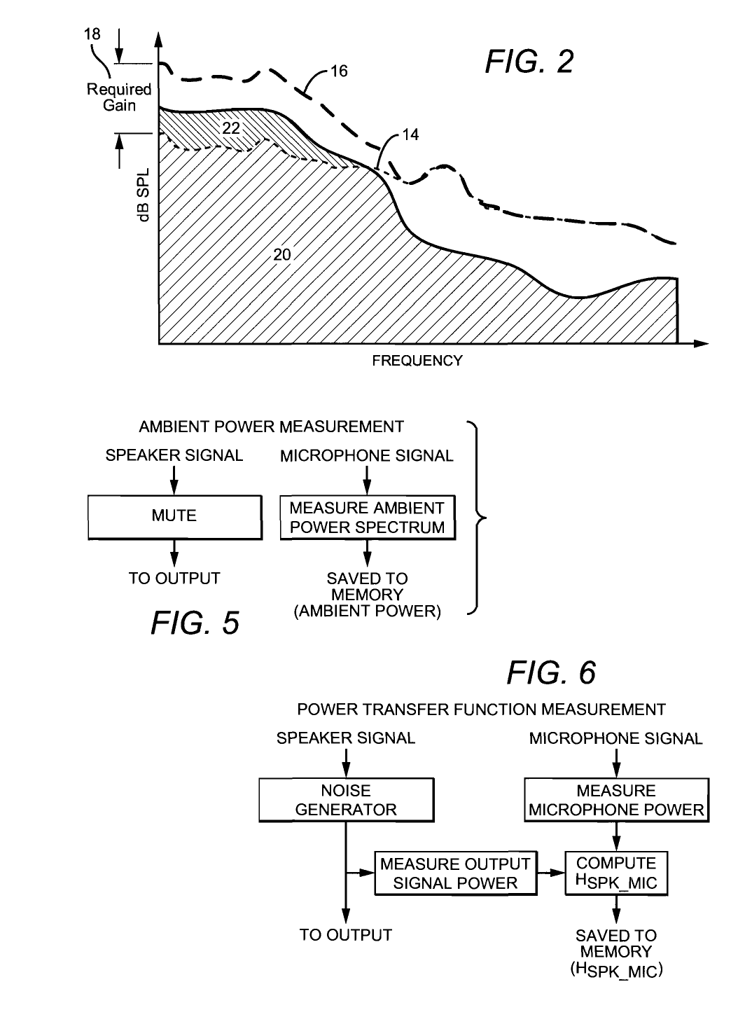

FIG. 2 provides a graphical representation of an audio signal 14 being processed by the ENC algorithm. The audio signal 14 is masked by an environment noise 20. As a result, a certain audio range 22 is lost in the noise 20 and inaudible. Once the ENC algorithm is applied, the audio signal is unmasked 16 and is clearly audible. Specifically, a required gain 18 is applied such that the unmasked audio signal 16 is realized.

Referring now to FIGS. 1 and 2, the desired soundtrack 14, 16 is separated from the background noise 20 based on a calibration which best approximates what the listener hears in the absence of noise. The real time microphone signal 24 during playback is subtracted from the predicted one and the difference represents the additional background noise.

The system is calibrated by measuring the signal path 26 between the speakers and the microphone. It is preferred the microphone 12 is positioned at the listening position 28 during this measurement process. Otherwise, the applied EQ (required gain 18) will adapt relative to the microphone's 12 perspective and not the listener's 28. Incorrect calibration may lead insufficient compensation of the background noise 20. The calibration may be preinstalled when the listener 28, speaker 30 and microphone 12 positions are predictable, such as laptops or the cabin of an automobile. Where positions are less predictable, calibration may need to be done within the playback environment before the system is used for the first time. An example of this scenario may be for a user listening to a movie soundtrack at home. The interfering noise 20 may come from any direction, thus the microphone 12 should have an omni-directional pickup pattern.

Once the soundtrack and the noise components have been separated, the ENC algorithm then models the excitation patterns that occur within the listeners inner ears (or cochleae) and further models the way in which background sounds can partially mask the loudness of foreground sounds. The level 18 of the desired foreground sound is increased enough so it may be heard above the interfering noise.

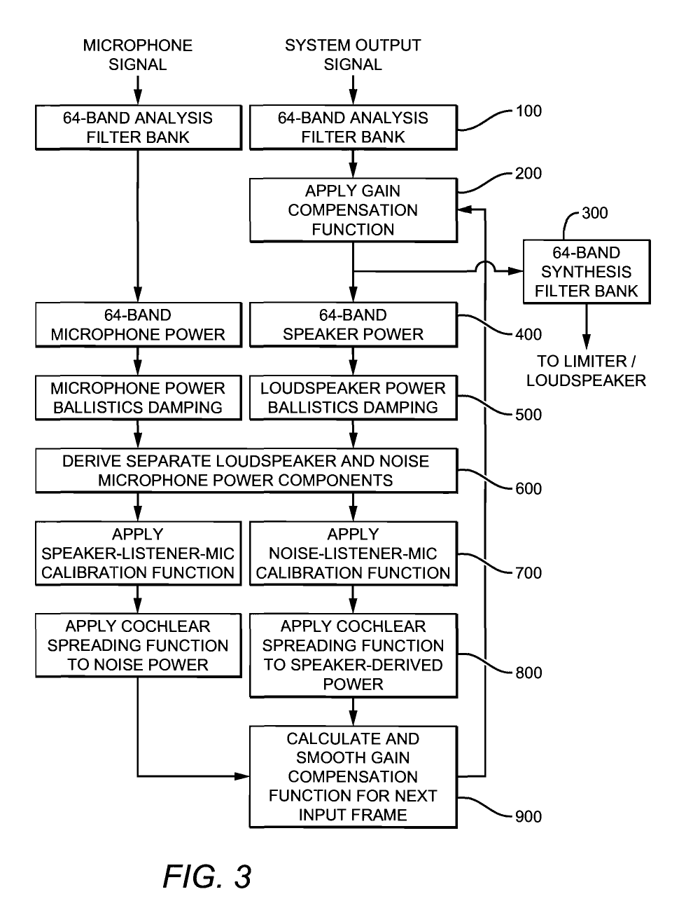

FIG. 3 provides a flowchart providing steps executed by the ENC algorithm. Each step of the execution of the method is detailed below. The steps are numbered and described according to their sequential position in the flowchart.

Now referring to FIGS. 1 and 3, at Step 100, the system output signal 32 and the microphone input signal 24 are converted to a complex frequency domain representation using 64-band oversampled polyphase analysis filter banks 34, 36. A person skilled in the art will understand that any technique for converting a time domain signal into the frequency domain may be employed and that the above described filter bank is provided by way of example and is not intended to limit the scope of the invention. In the currently described implementation, the system output signal 32 is assumed to be stereo and the microphone input 24 is assumed to be mono. However, the invention is not limited by the number of input or output channels.

At Step 200, the system output signals' complex frequency bands 38 are each multiplied by a 64-band compensation gain 40 function which was calculated during a previous iteration of the ENC method 42. However, at the first iteration of the ENC method, the gain function is assumed to be one in each band.

At Step 300, the intermediary signals produced by the applied 64-band gain function are sent to a pair of 64-band oversampled polyphase synthesis filter banks 46 which convert the signals back to the time domain. Subsequently, the time domain signals are then passed to a system output limiter and/or a D/A converter.

At Step 400, the power spectra of the system output signals 32 and the microphone signal 24 are calculated by squaring the absolute magnitude responses in each band.

At Step 500, the ballistics of the system output power and microphone power 24 are damped using a ‘leaky integration’ function,

P_{SPK}_{_{—}}_{OUT}(n)=αP_{SPK}_{_{—}}_{OUT}(n)+(1−α)P_{SPK}_{_{—}}_{OUT}(n−1) Equation 1a.

P_{MIC}(n)=αP_{MIC}(n)+(1−α)P_{MIC}(n−1) Equation 1b.

where P′ (n) is the smoothed power function, P(n) is the calculated power of the current frame, P(n−1) is the previous damped power value calculated and is a constant related to the attack and decay rate of the leaky integration function

$$α = 1 - {e}^{\frac{{T}_{frame}}{{T}_{c}}} . \qquad Equation 2$$

where T_{frame} is the time interval between successive frames of input data and T_{C} is the desired time constant. The power approximation may have a different T_{C} value in each band depending on whether power levels trends are increasing or decreasing.

Referring now to FIGS. 3 and 4, at Step 600, the (wanted) loudspeaker-derived power received at the microphone is separated from the (unwanted) extraneous noise-derived power. This is done by predicting the power 50 that should be received at the microphone position in the absence of extraneous noise using a pre-initialized model of the speaker-to-microphone signal path (H_{SPK}_{_{—}}_{MIC}) and subtracting that from the actual received microphone power. If the model includes an accurate representation of the listening environment the residual should represent the power of the extraneous background noise.

P_{SPK}=P_{SPKOUT}|H_{SPK}_{_{—}}_{MIC}|² Equation 3.

P_{NOISE}=P_{MIC}P_{SPK} Equation 4.

where P′_{SPK} is the approximated speaker-output related power at the listening position, P′_{NOISE} is the approximated noise related power at the listening position, P′_{SPKOUT} is the approximated power spectrum of the signal destined for the speaker output and P′_{MIC} is the approximated total microphone signal power. Note that a frequency domain noise gating function can be applied to P′_{NOISE} such that only noise power that is detected above a certain threshold will be included for analysis. This can be important when increasing the sensitivity of the loudspeaker gain to the background noise level (see G_{SLE} in step 900, below).

At Step 700, the derived values of (desired) speaker signal power and (undesired) noise power may need to be compensated for if the microphone is sufficiently far away from the listening position. In order to compensate for differences in microphone and listener position relative to speaker position, a calibration function may be applied to the derived speaker power contribution:

$$\begin{matrix}{C}_{SPK} = {\vert \frac{{H}_{SPK\_LIST}^{′}}{{H}_{SPK\_MIC}^{′}} \vert}^{2} . & Equation 5 \\ {P}_{SPK\_CAL}^{′} = {P}_{SPK}^{′} {C}_{SPK} . & Equation 6\end{matrix}$$

where C_{SPK} is the speaker power calibration function, H′_{SPK}_{_{—}}_{MIC} represents the response taken between the speaker(s) and the actual microphone position and H′_{SPK}_{_{—}}_{LIST} represents the response taken between the speaker(s) and the originally measured listening position at initialization.

Alternatively, if H′_{SPK}_{_{—}}_{LIST} is measured accurately during initialization, it may be assumed that P′_{SPK}=P′_{SPKOUT}|H′_{SPK}_{_{—}}_{LIST}|², is a valid representation of the power at the listening position, regardless of the final microphone position.

When a specific and predictable noise source is present, and to compensate for differences in microphone and listener position relative to that noise source, a calibration function may be applied to the derived noise power contribution.

$$\begin{matrix}{C}_{NOISE} = {\vert \frac{{H}_{NOISE\_LIST}^{′}}{{H}_{NOISE\_MIC}^{′}} \vert}^{2} . & Equation 7 \\ {P}_{NOISE}^{′} = {P}_{NOISE}^{′} {C}_{NOISE} . & Equation 8\end{matrix}$$

where C_{NOISE} is the noise power calibration function, H′_{NOISE}_{_{—}}_{MIC} represents the response taken between a speaker positioned at the noise source location and the actual microphone position and H′_{SPK}_{_{—}}_{LIST} represents the response taken between a speaker positioned at the noise source location and the originally measured listening position. In most applications, the noise power calibration function is likely to be in unity since the extraneous noise in general situations are either spatially diffuse or unpredictable in direction.

At Step 800, a cochlear excitation spreading function 48 is applied to the measured power spectra using a 64×64 element array of spreading weights, W. The power in each band is redistributed using a triangular spreading function W that peaks within the critical band under analysis and has slopes of around +25 and −10 dB per critical band before and after the main power band. This provides the effect of extending the loudness masking influence of noise in one band towards higher and (to a lesser degree) lowers bands in order to better mimic the masking properties of the human ear.

X_{c}=PₘW Equation 9.

where X_{c} represents the cochlear excitation function and Pₘ represents the measured power of the m^{th} block of data. Since, in this implementation, there is provided fixed linearly spaced frequency bands, the spreading weights are pre-warped from the critical band domain to the linear band domain and associated coefficients are applied using lookup tables.

At Step 900, the compensating gain EQ curve 52 is derived by the following equation, which is applied at every power spectral band:

$${G}_{comp} = \sqrt{{G}_{SLE} \frac{{X}_{c\_NOISE}}{{X}_{c\_SPK}} + 1} . \qquad Equation 10$$

This gain is limited to within the bounds of minimum and maximum ranges. In general, the minimum gain is 1 and the maximum gain is a function of the average playback input level. G_{SLE} represents a ‘Loudness Enhancement’ user parameter which can vary between 0 (no additional gains applied, regardless of the extraneous noise) and some maximum value defining the maximum sensitivity of loudspeaker signal gain to extraneous noise. The calculated gain function is updated using a smoothing function whose time constant is dependent on whether the per-band gains are on an attacking or a decaying trajectory.

$$\begin{matrix}If {G}_{comp} ( n ) > {G}_{comp}^{′} ( n - 1 ) , then \text{:} & \\ {G}_{comp}^{′} ( n ) = {α}_{a} {G}_{comp} ( n ) + ( 1 - {α}_{a} ) {G}_{comp}^{′} ( n - 1 ) . & Equation 11 \\ {α}_{a} = 1 - {e}^{\frac{{T}_{frame}}{{T}_{a}}} & Equation 12\end{matrix}$$

where Tₐ is an attack time constant

$$\begin{matrix}If {G}_{comp} ( n ) < {G}_{comp}^{′} ( n - 1 ) , then \text{:} & \\ {G}_{comp}^{′} ( n ) = {α}_{d} {G}_{comp} ( n ) + ( 1 - {α}_{d} ) {G}_{comp}^{′} ( n - 1 ) . & Equation 13 \\ {α}_{d} = 1 - {e}^{\frac{{T}_{frame}}{{T}_{d}} .} & Equation 14\end{matrix}$$

where T_{d} a decay time constant.

It is preferred that the attack time of the gain is slower than the decay time, as fast gains at a relative level are significantly more noticeable (deleterious) than a fast attenuation at a relative level. The damped gain function is finally saved for application to the next block of input data.

Now referring to FIG. 1, in a preferred embodiment the ENC algorithm 42 is initialized with reference measurements relating to the acoustics of the playback system and recording path. These references are measured at least once in the playback environment. This initialization process could take place inside the listening room upon system setup, or it may be pre-installed if the listening environment, speaker and microphone placement, and/or listening position are know (e.g. an automobile).

In a preferred embodiment, the ENC system initialization commences by measuring the ‘ambient’ microphone signal power, as further identified in FIG. 5. This measurement represents the typical electrical microphone and amplifier noise and also includes ambient room noise such as air conditioning, etc. Subsequently, the output channels are muted and the microphone is placed at the “listening position”.

The power of the microphone signal is measured by converting the time domain signal into the frequency domain signal using at least one 64-band oversampled polyphase analysis filter bank and squaring the absolute magnitude of the result. A person skilled in the art will understand that any technique for converting a time domain signal into the frequency domain may be employed and that the above described filter bank is provided by way of example and is not intended to limit the scope of the invention.

Subsequently, the power response is smoothed. It is contemplated that the power response may be smoothed using a leaky integrator, or the like. Afterwards, the power spectrum settles for a period of time to average out spurious noise. The resulting power spectrum is stored as a value. This ambient power measurement is subtracted from all microphone power measurements.

In an alternative embodiment, the algorithm may initialize by modeling the speaker-to-microphone transmission path, as depicted in FIG. 6. In the absence of spurious noise sources, a Gaussian white noise test signal is generated. It is contemplated that a typical random number approach, such as a “Box-Muller Transformation” may be employed. Subsequently, the microphone is placed at the listening position and the test signal is output on all channels.

The power of the microphone signal is computed by converting the time domain signal into the frequency domain signal using 64-band oversampled polyphase analysis filter banks, and squaring the absolute magnitude of the result.

Similarly, the power of the speaker output signal is computed (preferably before the D/A conversion), using the same technique. It is contemplated that the power response may be smoothed using a leaky integrator, or the like. Afterwards, compute the Speaker-to-Microphone “Magnitude Transfer Function”, which may be derived by:

$${H}_{SPK\_MIC} = \sqrt{\frac{MicPower - AmbientPower}{OutputSignalPower}} . \qquad Equation 15$$

where MicPower corresponds to the noise power calculated above, AmbientPower corresponds to the ambient noise power measured in the preferred embodiment described above, and OutputSignalPower represents the calculated signal power described above. The H_{SPK}_{_{—}}_{MIC} is smoothed over a period of time, preferably using a leaky integration function. Additionally, the H_{SPK}_{_{—}}_{MIC} is stored for later use in the ENC algorithm.

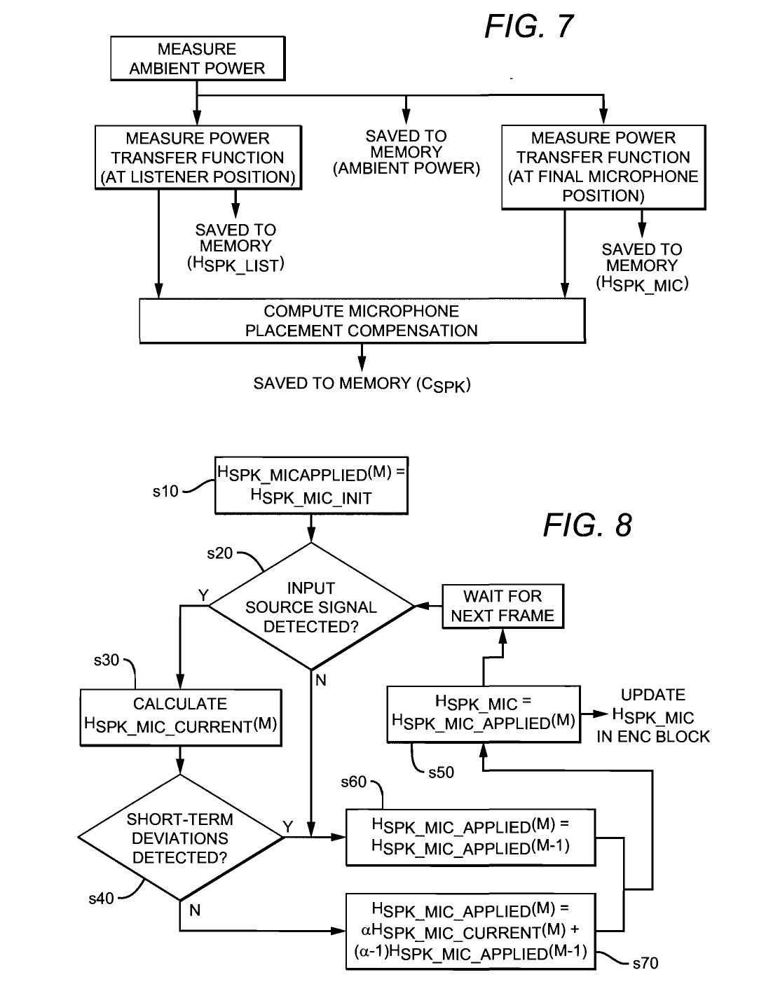

In a preferred embodiment, the microphone placement is calibrated to provide for enhanced accuracy, as depicted in FIG. 7. The initialization procedure is executed with the microphone placed at a primary listening position. The resulting speaker-listener magnitude transfer function, H_{SPK}_{_{—}}_{LIST}, is stored. Subsequently, the ENC initialization is repeated with the microphone placed at a location it will remain in while the ENC method is executed. The resulting speaker-mic magnitude transfer function, H_{SPK}_{_{—}}_{MIC}, is stored. Afterwards, calculate and apply the following microphone placement compensation function to the derived speaker-based signal power, as indicated in equations 5 and 6 above.

The performance of the ENC algorithm, as described above, depends on the accuracy of the loudspeaker to microphone path model, H_{SPK}_{_{—}}_{MIC}. In an alternative embodiment, the listening environment may change significantly after an initialization procedure has been performed thereby requiring a new initialization to be performed to yield an acceptable loudspeaker-to-microphone path model, as depicted in FIG. 8. If the listening environment changes frequently (for example, on a portable listening system going from room-to-room) it may be preferable to adapt the model to the environment. This may be accomplished by using the playback signal to identify the current loudspeaker-to-microphone magnitude transfer function as it is being played.

$${H}_{SPK\_MIC \_CURRENT} = \frac{{SPK\_OUT}^{*} MIC\_IN}{{\vert SPK\_OUT \vert}^{2}} . \qquad Equation 16$$

where SPK_OUT represents the complex frequency response of the current system output data frame (or speaker signal) and MIC_IN represents the complex frequency response of an equivalent data frame from the recorded microphone input stream. The * notation indicates a complex conjugate operation. Further descriptions of magnitude transfer functions are described in J. O. Smith, Mathematics of the Discrete Fourier Transform (DFT) with Audio Applications, 2^{nd} Edition, W3K publishing, 2008, hereby incorporated by reference.

Equation 16 is effective in a linear and time invariant system. A system may be approximated by time averaging measurements. The presence of significant background noise may challenge the validity of the current loudspeaker-to-microphone transfer function, H_{SPK}_{_{—}}_{MIC}_{_{—}}_{CURRENT}. Therefore, such a measurement may be made if there is no background noise. Therefore, an adaptive measurement system only updates the applied value, H_{SPK}_{_{—}}_{MIC}_{_{—}}_{APPLIED}, if it is relatively consistent across a series of consecutive frames.

The initialization commences at step s10 with an initialized value of H_{SPK}_{_{—}}_{MIC}_{_{—}}_{INIT}. This may be the last value stored or it may be a default factory-calibrated response or it may be the result of a calibration routine as previously described. The system proceeds to validates if an input source signal is present at step s20.

At step s30, the system calculates a newer version of H_{SPK}_{_{—}}_{MIC} for each input frame, called H_{SPK}_{_{—}}_{MIC}_{_{—}}_{CURRENT}. At step s40, the system checks for rapid deviations between H_{SPK}_{_{—}}_{MIC}_{_{—}}_{CURRENT} and previous measured values. If the deviations are small over some time window, the system is converging on a steady value for H_{SPK}_{_{—}}_{MIC} and we use the latest calculated value as the current value:

H_{SPK}_{_{—}}_{MIC}_{_{—}}_{APPLIED}(M)=H_{SPK}_{_{—}}_{MIC}_{_{—}}_{CURRENT}(M) (step s50)

Should the consecutive H_{SPK}_{_{—}}_{MIC}_{_{—}}_{CURRENT} values tend to deviate from the previously calculated values we say that the system is diverging (probably due to a change in environment or an external noise source) and we freeze the updates

H_{SPK}_{_{—}}_{MIC}_{_{—}}_{APPLIED}(M)=H_{SPK}_{_{—}}_{MIC}_{_{—}}_{APPLIED}(M−1) (step s60)

until consecutive H_{SPK}_{_{—}}_{MIC}_{_{—}}_{CURRENT} values converge once more. H_{SPK}_{_{—}}_{MIC}_{_{—}}_{APPLIED} would then be updated by ramping its coefficients towards H_{SPK}_{_{—}}_{MIC}_{_{—}}_{CURRENT} over a set period of time, short enough to mitigate possible audio artifacts resulting from filter updates.

H_{SPK}_{_{—}}_{MIC}_{_{—}}_{APPLIED}(M)=αH_{SPK}_{_{—}}_{MIC}_{_{—}}_{CURRENT}(M)+(1+α)H_{SPK}_{_{—}}_{MIC}_{_{—}}_{APPLIED}(M−1) (step s70)

The value H_{SPK}_{_{—}}_{MIC} should not be calculated when no source audio signal is detected as this could lead to a ‘divide by zero’ scenario where the value becomes very unstable or undefined.

A reliable ENC environment may be implemented without employing speaker-to-microphone path delays. Instead, the algorithm input signals are integrated (leaky) with sufficiently long time constants. Thus, by reducing the reactivity of the inputs, the predicted microphone energy is likely to correspond more closely to the actual energy (itself less reactive). The system is thereby less responsive to short term changes in background noise (such as occasional speech or coughing, etc.), but retains the ability to identify longer instances of spurious noise (such as a vacuum cleaner, car engine noise, etc.).

However, if the input/output ENC system exhibits sufficiently long i/o latency, there may be a significant difference between the predicted microphone power and the actual microphone power that cannot be attributed to extraneous noise. In this case, gains may be applied when they are not warranted.

Therefore, it is contemplated that the time delay may be measured between the inputs of the ENC method at initialization or adaptively in real-time using methods such as correlation-based analysis and apply the same to the microphone power prediction. In this case, equation 4 may be written as

P′_{NOISE}[N]=P′_{MIC}[N]−P′_{SPK}[N−D]

where [N] corresponds to the current energy spectrum and [N−D] corresponds to the (N−D)th energy spectrum, D being an integer number of delayed frames of data.

For movie watching it may be preferable to only apply our compensation gain to dialog. This might require some kind of dialog extraction algorithm and restricting our analysis between the dialog-biased energy and the detected environmental noise.

It is contemplated that theory applies to multichannel signals. In this case, the ENC method includes the individual speaker-to-microphone paths and ‘predicts’ the microphone signal based on a superposition of speaker channel contributions. For multichannel implementations, it may be preferable to apply a derived gain to the center (dialog) channel only. However, the derived gain may be applied to any channel of a multi-channel signal.

For systems not having microphone inputs, yet retaining a predictable background noise characteristic (e.g. a plane, train, air-conditioned room, etc) both the predicted perceived signal and predicted perceived noise may be simulated using preset noise profiles. In such an embodiment, the ENC algorithm stores a 64-band noise profile and compares its energy to a filtered version of the output signal power. The filtering of the output signal power would attempt to emulate power reductions due to predicted loudspeaker SPL capabilities, air transmission loss, and so forth.

The ENC method may be enhanced if spatial qualities of the external noise were known relative to the spatial characteristic of the playback system. This may be accomplished using a multichannel microphone, for example.

It is contemplated that the ENC method may be effective when employed with Noise cancelling headphones such that the environment includes a microphone and headphones. It is recognized that noise cancellers may be limited at high frequencies and the ENC method may assist to bridge that gap.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show particulars of the present invention in more detail than is necessary for the fundamental understanding of the present invention, the description taken with the drawings making apparent to those skilled in the art how the several forms of the present invention may be embodied in practice.

We claim:

1. A method for modifying an audio source signal to compensate for environmental noise, comprising:
receiving the audio source signal;
computing a power spectrum of the audio source signal;
receiving an external audio signal having a signal component and a residual noise component;
computing a power spectrum of the external audio signal;
predicting an expected power spectrum for the external audio signal;
deriving a residual power spectrum based on differences between expected power spectrum and the external power spectrum; and
applying a frequency-dependent gain to the audio source signal, the gain being determined by comparing the expected power spectrum and the residual power spectrum.

2. The method in claim 1, wherein the predicting step includes a model of the expected audio signal path between the audio source signal and the associated external audio signal.

3. The method in claim 2, wherein the model initializes based on a system calibration having a function of a reference audio source power spectrum and the associated external audio power spectrum.

4. The method in claim 2, wherein the model includes an ambient power spectrum of the external audio signal measured in the absence of an audio source signal.

5. The method in claim 2, wherein the model incorporates a measure of time delay between the audio source signal and the associated external audio signal.

6. The method in claim 2, wherein the model is continuously adapted based on a function of the audio source magnitude spectrum and the associated external audio magnitude spectrum.

7. The method of claim 1, wherein the power spectrums are smoothed such that the gain is properly modulated.

8. The method of claim 7, wherein the power spectrums are smoothed using leaky integrators.

9. The method of claim 1, wherein a cochlear excitation spreading function is applied to the spectral energy bands mapped on an array of spreading weights, the array of spreading weights having a plurality of grid elements, represented as:
E_{c}=EₘW
wherein
E_{c} represents the cochlear excitation function;
Eₘ represents the m^{th} element of the grid; and
W represents the spreading weight.

10. The method of claim 1, wherein the external audio signal is received through a microphone.

11. A method for modifying an audio source signal to compensate for environmental noise, comprising:
receiving the audio source signal;
parsing the audio source signal into a plurality of frequency bands;
computing a power spectrum from magnitudes of the audio source signal frequency bands;
predicting an expected power spectrum for an external audio signal;
looking up a residual power spectrum based on a stored profile; and
applying a gain to each frequency band of the audio source signal, the gain being determined by a ratio of the expected power spectrum and the residual power spectrum.

12. An apparatus for modifying an audio source signal to compensate for environmental noise, comprising:
a first receiver processor for receiving the audio source signal and parsing the audio source signal into a plurality of frequency bands, wherein a power spectrum is computed from magnitudes of the audio source signal frequency bands;
a second receiver processor for receiving an external audio signal having a signal component and a residual noise component, and for parsing the external audio signal into a plurality of frequency bands, wherein an external power spectrum is computed from magnitudes of the external audio signal frequency bands; and
a computing processor for predicting an expected power spectrum for the external audio signal, and deriving a residual power spectrum based on differences between expected power spectrum and the external power spectrum, wherein a gain is applied to each frequency band of the audio source signal, the gain being determined by a ratio of the expected power spectrum and the residual power spectrum.

13. The apparatus of claim 12, wherein a model of the expected audio signal path between the audio source signal and the associated external audio signal is determined.

14. The apparatus of claim 13, wherein the model initializes based on a system calibration having a function of a reference audio source power spectrum and the associated external audio power spectrum.

15. The apparatus of claim 13, wherein the model includes an ambient power spectrum of the external audio signal measured in the absence of an audio source signal.

16. The apparatus of claim 13, wherein the model incorporates a measure of time delay between the audio source signal and the associated external audio signal.

17. The apparatus of claim 13, wherein the model is continuously adapted based on a function of the audio source magnitude spectrum and the associated external audio magnitude spectrum.
